(19) United States
(12) Patent Application Publication
(10) Pub. No.: US 2025/0344733 A1
(43) Pub. Date: Nov. 13, 2025

(54) FLAVOR NANOEMULSIONS FOR BEVERAGE AND PERSONAL CARE APPLICATIONS

(71) Applicant: FIRMENICH SA, Satigny (CH)

(72) Inventors: Qiu-Min MA, Shanghai (CN); Wenhao LI, Shanghai (CN)

(73) Assignee: FIRMENICH SA, Satigny (CH)

(21) Appl. No.: 18/867,926

(22) PCT Filed: May 8, 2023
(86) PCT No.: PCT/EP2023/062087

§ 371 Date: Nov. 21, 2024

(30) Foreign Application Priority Data
May 30, 2022 (WO) PCT/CN2022/095965
Jul. 29, 2022 (EP) 22187910.9

(51) Int. Cl. A23L 27/00; A23D 7/005; A23D 7/01; A23L 2/56; A23L 27/12

(52) U.S. Cl. CPC A23L 27/80; A23D 7/0053; A23D 7/011; A23L 2/56; A23L 27/13

(57) ABSTRACT

The present invention relates to a flavor nanoemulsion comprising a surfactant system comprising a polyglycerol ester of fatty acids (PGE), a non-polar phase comprising a flavor oil, and a polar phase. The invention further relates to a flavored beverage comprising the flavor nanoemulsion described herein.

### TECHNICAL FIELD

The present disclosure relates to a flavor nanoemulsion comprising a surfactant system comprising a polyglycerol ester of fatty acids (PGE), a non-polar phase comprising a flavor oil, and a polar phase, wherein the flavor nanoemulsion is free of any polyoxyethylene sorbitan fatty acid esters. The disclosure further relates to a flavored beverage comprising the flavor nanoemulsion according to the invention.

### BACKGROUND OF THE INVENTION

For beverage applications, flavor compositions are desired.

Flavor compositions are often in the form of emulsions comprising a polar phase, an oil phase, as well as a surfactant system. The aqueous phase typically comprises water and/or one or more polar co-solvents and further ingredients. The oil phase is typically dispersed within the aqueous phase thereby forming an oil-in-water emulsion. The dispersed oil phase typically comprises flavor oil(s) and optionally further lipophilic ingredients.

Such flavor emulsions have to fulfill a range of requirements. First of all, they should show a certain stability over a wide range of temperatures and storage conditions both in concentrated and in diluted form, i.e., within a beverage or personal care product. Moreover, the flavor composition should be clear in appearance after dilution, i.e., in a beverage.

Moreover, for universal applicability, flavor emulsions should also be stable in beverages showing acidic pH levels as well as in alcoholic beverages. However, many known flavor emulsions are hardly stable in acidic beverages and/or alcoholic beverages, as, in some instances, the surfactant system used may not be stable under acidic conditions or in the presence of ethanol.

In order to be useful for beverage applications, flavor emulsions also have to be able to carry sufficiently high amounts of flavor oil without showing any disadvantages as to the stability or appearance. A certain proportion of flavor oil in the flavor emulsion is needed in order to effectively provide flavor to a beverage.

Flavor emulsions can be in the form of a microemulsion or in the form of a nanoemulsion. Although less energy input is required to produce microemulsions and often higher oil loads are possible for microemulsions compared to nanoemulsions, a major disadvantage of flavor microemulsions is that microemulsions are typically very sensitive to composition changes, i.e., the formulation of the microemulsions often needs to be adapted for each individual type of flavor oil that is to be integrated in the flavor microemulsion. This is not only cumbersome, but also represents a big challenge for production at industrial scale. Therefore, flavor emulsions would be desirable, wherein the flavor emulsion formulation is less dependent or even independent of the individual flavor oil used, which would be particularly useful for production at industrial scale.

Moreover, in microemulsions often high amounts of water soluble and hydrophilic surfactants are required, which may result in foaming issues during beverage manufacturing making use of such microemulsions.

The present invention provides solutions for the above-mentioned advantages, and solutions to overcome one or more of the above-mentioned disadvantages associated with known flavor emulsions.

### SUMMARY OF THE DISCLOSURE

In a first aspect, the present disclosure relates to a flavor nanoemulsion comprising:
a surfactant system comprising a polyglycerol ester of fatty acids (PGE),
a non-polar phase comprising a flavor oil, and
a polar phase;
wherein the flavor nanoemulsion is free of any polyoxyethylene sorbitan fatty acid esters.

In a second aspect, the present disclosure relates to a flavored beverage comprising the flavor nanoemulsion described herein.

### DETAILED DESCRIPTION OF THE DISCLOSURE

Unless defined otherwise, all technical and scientific terms used herein have the same meaning as is commonly understood by one of skill in the art to which this specification pertains.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

While compositions and/or methods are described in terms of “comprising,” “containing,” or “including” various components or steps, the compositions and/or methods can also “consist essentially of” or “consist of” the various components, substances and steps. As used herein the term “consisting essentially of” shall be construed to mean including the listed components, substances or steps and such additional components, substances or steps which do not materially affect the basic and novel properties of the composition or method. In some embodiments, a composition in accordance with embodiments of the present disclosure that “consists essentially of” the recited components or substances does not include any additional components or substances that alter the basic and novel properties of the composition. As used herein the term “consisting of” shall be construed to mean including only the listed components, substances or steps.

If there is any conflict in the usages of a word or term in this specification and one or more patent or other documents that may be incorporated herein by reference, the definitions that are consistent with this specification should be adopted.

In the first aspect, the present disclosure relates to a flavor nanoemulsion comprising:
a surfactant system comprising a polyglycerol ester of fatty acids (PGE),
a non-polar phase comprising a flavor oil, and
a polar phase;
wherein the flavor nanoemulsion is free of any polyoxyethylene sorbitan fatty acid esters.

An emulsion is a mixture of two liquids that are immiscible due to their different polarities (hydrophobic vs. hydrophilic). In an emulsion, one liquid (dispersed or internal phase) is dispersed in another liquid (external or continuous phase). Therefore, the non-polar phase may be dispersed within the polar-phase, or the polar phase may be dispersed within the non-polar phase.

In a particular embodiment, the non-polar phase is dispersed within the polar phase. In another particular embodiment, the polar phase is dispersed within the non-polar phase. Typically, the non-polar phase is dispersed within the polar phase.

Double emulsions, such as water-in-oil-in-water (WOW) emulsions and its opposite, oil-in-water-in-oil (OWO) emulsions, with three distinct phases are known. With respect to the WOW type, the three distinct phases consist of polar phase droplets that are dispersed in a non-polar phase, which is then enclosed in a continuous polar phase. Such emulsions are not contemplated in the present disclosure. Therefore, the emulsions of the present disclosure are not double emulsions, i.e., the emulsions of the present disclosure are neither water-in-oil-in-water (WOW) emulsions nor oil-in-water-in-oil (OWO) emulsions. In an embodiment, the non-polar phase is dispersed within the polar phase and the non-polar phase is free of any polar phase. In another embodiment, the polar phase is dispersed within the non-polar phase and the polar phase is free of any non-polar phase. Typically, the non-polar phase is dispersed within the polar phase and the non-polar phase is free of any polar phase.

Unless otherwise stated, the phrase “free of” means that there is no external addition of the material immediately following the phrase and that there is no detectable amount of the material that may be observed by analytical techniques known to the ordinarily-skilled artisan, such as, for example, gas or liquid chromatography, spectrophotometry, optical microscopy, and the like.

According to the present disclosure, the emulsion is a nanoemulsion. In contrast to microemulsions, nanoemulsions are usually prepared by high-energy input, such as high-pressure homogenization to break the big droplets into small ones.

The droplet size, measured as the intensity weighted mean hydrodynamic diameter (Z-average value) of the oil droplets in the nanoemulsion, is below 500 nm, typically below 200 nm.

In a particular embodiment, the intensity weighted mean hydrodynamic diameter (Z-average value) of the oil droplets in the nanoemulsion is from 50 to 150 nm, typically from 70 to 120 nm. Droplet sizes can be measured using instrumentation and methods known to those of ordinary skill in the art, for example, using a Zetasizer nano ZS (Malvern Instruments Limited, Worcs, UK).

According to the present disclosure, the flavor nanoemulsion is free of any polyoxyethylene sorbitan fatty acid esters. Polyoxyethylene sorbitan fatty acid esters are nonionic surfactants that are typically obtained by the reaction of ethylene oxide with sorbitan fatty acid esters. Such polyoxyethylene sorbitan fatty acid esters are not contemplated in the present disclosure.

A surfactant system is required to obtain a nanoemulsion that is at least stable for a certain period of time. Surfactants (emulsifiers) show amphiphilic properties meaning that they contain both hydrophobic and hydrophilic moieties. Based on these structural properties, surfactants are surface-active, which allows them to reduce the interfacial tension between a polar and non-polar phase and thus, to stabilize an emulsion.

According to the invention, the surfactant system comprises a polyglycerol ester of fatty acids (PGE). In an embodiment, the surfactant system consists of a polyglycerol ester of fatty acids (PGE).

In an embodiment, the polyglycerol ester of fatty acids has a degree of polymerization of from 2 to 10 glycerol units.

In an embodiment, the fatty acids in the polyglycerol ester have a carbon number of from 12 to 18. Typically, the carbon number is from 16 to 18, more typically the carbon number is 18.

In a particular embodiment, the fatty acids in the polyglycerol ester are saturated fatty acids. Typically, the saturated fatty acids are selected from the group consisting of lauric acid, myristic acid, palmitic acid, stearic acid, or any mixture thereof. More typically, the fatty acid is stearic acid.

In a particular embodiment, the fatty acids in the polyglycerol ester are unsaturated fatty acids. Typically, the unsaturated fatty acids are selected from the group consisting of oleic acid, linoleic acid, and linolenic acid. More typically, the unsaturated fatty acid is oleic acid.

In a particular embodiment, the polyglycerol ester of fatty acids (PGE) is selected from the group consisting of triglyceryl monostearate, hexaglycerol penta-stearate, hexaglycerol tri-stearate, tetraglycerol mono-oleate, decaglycerol mono-oleate, and any mixture thereof. In a particular embodiment, the polyglycerol ester of fatty acids (PGE) is decaglycerol mono-oleate.

The HLB-value of the polyglycerol ester of fatty acids (PGE) used according to the present disclosure is not particularly limited. However, in an embodiment, the polyglycerol ester of fatty acids (PGE) has an HLB-value of less than 16.

The amount of polyglycerol ester of fatty acids (PGE) in the flavor composition described herein is not particularly limited. However, good results are obtained when the nanoemulsion comprises the polyglycerol ester of fatty acids (PGE) in an amount of from 1 to 20 wt. %, typically from 6 to 16 wt. %, based on the total weight of the nanoemulsion.

In some embodiments, the surfactant system may comprise surfactants other than polyglycerol ester of fatty acids (PGE). However, some surfactants are not contemplated, such as sugar esters. Thus, in some embodiments, the surfactant system is free of sugar esters, such as sucrose esters like those selected from the group consisting of sucrose mono- and dimyristate, sucrose acetate isobutyrate, sucrose laurate, sucrose monolaurate, sucrose palmitate, sucrose monopalmitate, and combinations thereof.

The nanoemulsion according to the present disclosure comprises a non-polar phase comprising a flavor oil.

As used herein, the “non-polar phase” is to be understood as including the total amount of hydrophobic compounds in the nanoemulsion according to the present disclosure.

In some embodiments, the non-polar phase is present in the nanoemulsion in an amount of from 0.5 to 30 wt. %, typically from 10 to 25 wt. %, based on the total weight of the nanoemulsion.

According to the present disclosure, the non-polar phase comprises a flavor oil. In an embodiment, the non-polar phase consists of flavor oil.

By “flavor oil”, it is meant here a flavoring ingredient or a mixture of flavoring ingredients, solvent or adjuvants of current use for the preparation of a flavoring formulation, i.e., a particular mixture of ingredients which is intended to be added to a composition to impart, improve or modify its organoleptic properties, in particular its flavor and/or taste. Taste modulators are also encompassed in said definition. Flavoring ingredients are well known to a skilled person in the art and their nature does not warrant a detailed description here, which in any case would not be exhaustive, the ordinarily-skilled flavorist being able to select them on the basis of his/her general knowledge and according to the intended use or application and the organoleptic effect it is desired to achieve. Many of these flavoring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, can Nostrand Co., Inc. Solvents and adjuvants or current use for the preparation of a flavoring formulation are also well known in the art.

In a particular embodiment, the flavor oil is selected from the group consisting of limonene, orange oil, lemon oil, grapefruit oil, lime oil, calamansi oil, and any mixture thereof.

In a particular embodiment, the flavor oil comprises limonene. Typically, the flavor oil consists of limonene.

In a particular embodiment, the flavor oil comprises orange oil. Typically, the flavor oil consists of orange oil.

In a particular embodiment, the flavor oil comprises lemon oil. Typically, the flavor oil consists of lemon oil.

In a particular embodiment, the flavor oil comprises grapefruit oil. Typically, the flavor oil consists of grapefruit oil.

In a particular embodiment, the flavor oil comprises lime oil. Typically, the flavor oil consists of lime oil.

In a particular embodiment, the flavor oil comprises calamansi oil. Typically, the flavor oil consists of calamansi oil.

In a particular embodiment, the flavor oil comprises lemon oil, grapefruit oil, lime oil, and calamansi oil. Typically, the flavor oil consists of lemon oil, grapefruit oil, lime oil, and calamansi oil.

In an embodiment, the nanoemulsion comprises the flavor oil in an amount of from 0.5 to 30 wt. %, typically from 5 to 25 wt. %, more typically from 5 to 15 wt. %, based on the total weight of the nanoemulsion.

The non-polar phase may further comprise one or more other active ingredients selected from oil-soluble pharmaceutical ingredients, oil-soluble nutraceutical ingredients (e.g., oil-soluble vitamins), oil-soluble colorants, oil-soluble antimicrobial ingredients, oil-soluble defoamers, oil-soluble antioxidants, such as Vitamin E, mouthfeel modulators, taste modulators, or any combinations thereof.

Useful taste modulators include, but are not limited to, acid maskers, beer hops, cooling agents, hot tasting substances, sweet enhancers, salt enhancers, salivation-inducing substances, substances causing a warmth or tingling feeling, and any combinations thereof.

Suitable cooling agents include, but are not limited to,
2-methyl-1-(2-(5-(p-tolyl)-1H-imidazol-2-yl)piperidin-1-yl)butan-1-one (FEMA 4970),
2-(4-methylphenoxy)-N-(1H-pyrazol-5-yl)-N-(2-thienylmethyl) acetamide,
2-Isopropyl-N,2,3-trimethylbutyramide (WS-23, FEMA 3804),
N-Ethyl-p-menthane-3-carboxamide (WS-3, FEMA 3455),
Ethyl 3-(p-menthane-3-carboxamido)acetate (WS-5, FEMA 4309),
(1R,2S,5R)—N-(4-Methoxyphenyl)-p-menthanecarboxamide (WS-12, FEMA 4681),
N-Ethyl-2,2-diisopropylbutanamide (WS-27, FEMA 4557),
N-Cyclopropyl-5-methyl-2-isopropylcyclohexanecarboxamide (WS-116, FEMA 4693),
N-(1,1-Dimethyl-2-hydroxyethyl)-2,2-diethylbutanamide (FEMA 4603),
Menthoxyethanol (FEMA 4154),
N-(4-cyanomethylphenyl)-p-menthanecarboxamide (FEMA 4496),
N-(2-(Pyridin-2-yl)ethyl)-3-p-menthanecarboxamide (FEMA 4549),
N-(2-Hydroxyethyl)-2-isopropyl-2,3-dimethylbutanamide (FEMA 4602)
(2S,5R)—N-[4-(2-Amino-2-oxoethyl)phenyl]-p-menthanecarboxamide (FEMA 4684),
N-Cyclopropyl-5-methyl-2-isopropylcyclohexanecarbonecarboxamide (FEMA 4693),
2-[(2-p-Menthoxy)ethoxy]ethanol (FEMA 4718),
2,6-Diethyl-5-isopropyl-2-methyltetrahydropyran (FEMA 4680),
trans-4-tert-Butylcyclohexanol (FEMA 4724),
2-(p-tolyloxy)-N-(1H-pyrazol-5-yl)-N-((thiophen-2-yl)methyl) acetamide (FEMA 4809),
Menthone glycerol ketal (FEMA 3807),
L-menthyl lactate (FEMA 3748),
(−)-Menthoxypropane-1,2-diol,
3-(L-Menthoxy)-2-methylpropane-1,2-diol (FEMA 3849),
Isopulegol,
(+)-cis & (−)-trans p-Menthane-3,8-diol, Ratio ˜62:38 (FEMA 4053),
2,3-dihydroxy-p-menthane,
3,3,5-trimethylcyclohexanone glycerol ketal,
menthyl pyrrolidone carboxylate,
(1R,3R,4S)-3-menthyl-3,6-dioxaheptanoate,
(1R,2S,5R)-3-menthyl methoxyacetate,
(1R,2S,5R)-3-menthyl 3,6,9-trioxadecanoate,
(1R,2S,5R)-3-menthyl (2-hydroxyethoxy)acetate,
(1R,2S,5R)-menthyl 11-hydroxy-3,6,9-trioxaundecanoate,
Cubebol (FEMA 4497),
N-(4-cyanomethylphenyl) p-menthanecarboxamide (FEMA 4496),
2-isopropyl-5-methylcyclohexyl 4-(dimethylamino)-4-oxobutanoate (FEMA 4230),
N-(4-cyanomethylphenyl) p-menthanecarboxamide (FEMA 4496),
N-(2-pyridin-2-ylethyl) p-menthanecarboxamide (FEMA 4549),
6-isopropyl-3,9-dimethyl-1,4-dioxaspiro[4.5]decan-2-one (FEMA 4285),
N-benzo[1,3]dioxol-5-yl-3-p-menthanecarboxamide,
N-(1-isopropyl-1,2-dimethylpropyl)-1,3-benzodioxole-5-carboxamide,
N—(R)-2-oxotetrahydrofuran-3-yl-(1R,2S,5R)-p-menthane-3-carboxamide,
mixture of 2,2,5,6,6-pentamethyl-2,3,6,6a-tetrahydropentalen-3a (1H)-ol and 5-(2-hydroxy-2-methylpropyl)-3,4,4-trimethylcyclopent-2-en-1-one,
(2S,5R)-2-isopropyl-5-methyl-N-(2-(pyridin-4-yl)ethyl)cyclohexanecarboxamide,
(1S,2S,5R)—N-(4-(cyanomethyl)phenyl)-2-isopropyl-5-methylcyclohexanecarboxamide,
1/7-isopropyl-4/5-methyl-bicyclo[2.2.2]oct-5-ene derivatives,
4-methoxy-N-phenyl-N-[2-(pyridin-2-yl)ethyl]benzamide,
4-methoxy-N-phenyl-N-[2-(pyridin-2-yl)ethyl]benzenesulfonamide,
4-chloro-N-phenyl-N-[2-(pyridin-2-yl)ethyl]benzenesulfonamide,
4-cyano-N-phenyl-N-[2-(pyridin-2-yl)ethyl]benzenesulfonamide,
4-((benzhydrylamino)methyl)-2-methoxyphenol,
4-((bis(4-methoxyphenyl)-methylamino)-methyl)-2-methoxyphenol,
4-((1,2-diphenylethylamino)methyl)-2-methoxyphenol,
4-((benzhydryloxy)methyl)-2-methoxyphenol,
4-((9H-fluoren-9-ylamino)methyl)-2-methoxyphenol,
4-((benzhydrylamino)methyl)-2-ethoxyphenol,
1-(4-methoxyphenyl)-2-(1-methyl-1H-benzo[d]imidazol-2-yl) vinyl4-methoxybenzoate,
2-(1-isopropyl-6-methyl-1H-benzo[d]imidazol-2-yl)-1-(4-methoxyphenyl)vinyl4-methoxybenzoate,
(Z)-2-(1-isopropyl-5-methyl-1H-benzo[d]imidazol-2-yl)-1-(4-methoxy-phenyl)vinyl-4-methoxybenzoate,
3-alkyl-p-methan-3-ol derivatives,
Esters of fenchol, D-borneol, L-borneol, exo-norborneol, 2-methylisoborneol, 2-ethylfenchol, 2-methylborneol, cis-pinan-2-ol, verbenol, or isoborneol,
menthyl oxamate derivatives,
menthyl 3-oxocarboxylic acid esters,
N-alpha-(menthanecarbonyl) amino acid amides,
(−)-(1R,2R,4S)-dihydroumbellulol,
p-menthane alkyloxy amides,
a mixture of 3-menthoxy-1-propanol and 1-menthoxy-2-propanol,
1-(2-hydroxyphenyl)-4-(2-nitrophenyl-)-1,2,3,6-tetrahydropyrimidine-2-one,
4-methyl-3-(1-pyrrolidinyl)-2 [5H]-furanone,
derivatives thereof and any combinations thereof.

Exemplary mouthfeel modulators include, but are not limited to, coconut oil, coconut milk with or without sugar, vanillin; medium chain monoglycerides, diglycerides, and triglycerides; and any combinations thereof.

The nanoemulsion according to the present disclosure comprises a polar phase.

As used herein, the “polar phase” is to be understood to include the total amount of hydrophilic compounds in the nanoemulsion according to the invention.

In an embodiment, the polar phase comprises water. In another embodiment, the nanoemulsion comprises water in an amount of from 20 to 85 wt. %, typically from 30 to 80 wt. %, based on the total weight of the nanoemulsion.

The polar phase may further comprise one or more additives, typically ingestible additives, suitable for use in flavor nanoemulsions. Exemplary additives include, but are not limited to, salts, sugar alcohols, saccharides, and the like.

In an embodiment, the polar phase comprises a salt, typically alkali metal salt, more typically sodium chloride.

In an embodiment, the polar phase comprises a sugar alcohol, typically a sugar alcohol selected from the group consisting of xylitol, sorbitol, mannitol, maltitol, inositol, allitol, altritol, dulcitol, galactitol, glucitol, hexitol, iditol, pentitol, ribitol, erythritol and mixtures thereof.

In an embodiment, the polar phase comprises a saccharide, typically a monosaccharide, disaccharide, or polysaccharide.

In an embodiment, the polar phase comprises a monosaccharide, typically a monosaccharide selected from the group consisting of glucose, fructose, ribose, xylose, mannose, and mixtures thereof.

In another embodiment, the polar phase comprises a disaccharide, typically a disaccharide selected from the group consisting of sucrose, lactose, maltose, and mixtures thereof.

In a particular embodiment, the polar phase comprises a polar non-aqueous solvent.

As used herein, a “polar non-aqueous solvent” is to be understood as being a polar (hydrophilic) solvent that is not water.

In an embodiment, the polar non-aqueous solvent is a food-grade solvent suitable for use in food compositions. In some embodiments, the polar non-aqueous solvent is a food-grade solvent suitable for use in food compositions in combination with flavor ingredients.

In an embodiment, the polar phase comprises a non-aqueous solvent selected from the group consisting of glycerol, propylene glycol, benzylic alcohol, ethanol, propanol, isopropanol, 1,3-propanediol, butanol, butylene glycol, hexylene glycol, dipropylene glycol, ethoxydiglycol, triacetine, and any mixture thereof. Typically, the polar non-aqueous solvent is glycerol. In an embodiment, the polar phase comprises glycerol.

In some embodiments, the non-aqueous solvent is free of ethanol and is selected from the group consisting of glycerol, propylene glycol, benzylic alcohol, propanol, isopropanol, 1,3-propanediol, butanol, butylene glycol, hexylene glycol, dipropylene glycol, ethoxydiglycol, triacetine, and any mixture thereof.

In an embodiment, the nanoemulsion comprises glycerol in an amount of from 0.1 to 70 wt. %, based on the total weight of the nanoemulsion, typically from 1 to 40 wt. %, more typically in an amount of from 30 to 40 wt. %. In some embodiments, the nanoemulsion comprises glycerol in an amount of from 0.1 to 35 wt. %, based on the total weight of the nanoemulsion, typically from 1 to 35 wt. %, more typically in an amount of from 30 to 35 wt. %.

In an embodiment, the mass ratio of glycerol to the polyglycerol ester of fatty acids (PGE) is from 20:1 to 1:20, typically from 10:1 to 1:10, more typically 5:1 to 1:5.

In a particular embodiment, the polar phase comprises water and a non-aqueous solvent, the non-aqueous solvent selected from the group consisting of glycerol, propylene glycol, benzylic alcohol, ethanol, propanol, isopropanol, 1,3-propanediol, butanol, butylene glycol, hexylene glycol, dipropylene glycol, ethoxydiglycol, triacetine, and any mixture thereof. Typically, the polar phase comprises water and glycerol. In an embodiment, the polar phase consists of water and glycerol.

In a particular embodiment, the nanoemulsion is clear in appearance, i.e., a clear composition. Compositions having a NTU value of less than 10 are considered to have a clear appearance.

The flavor nanoemulsion described herein may be obtained using methods known to those of ordinary skill in the art. In a suitable method, the nanoemulsion according to the present disclosure may be obtained by a method comprising mixing a non-polar phase comprising a flavor oil and a polar phase in the presence of a surfactant system comprising a polyglycerol ester of fatty acids (PGE).

In an embodiment, the polyglycerol ester of fatty acids is added to the polar phase, typically comprising water, more typically comprising water and glycerol, before the mixing of the polar phase with the non-polar phase is conducted. Typically, the polar phase is blended with the polyglycerol ester of fatty acids at a temperature of from 20 to 25° C. (room temperature) before being mixed with the non-polar phase.

In an embodiment, the mixing of the non-polar phase and the polar phase is performed by using a high-speed homogenizer at between 1000 rpm and 25000 rpm, typically from 8000 rpm and 12000 rpm, more typically at 10000 rpm. In some embodiments, the high-speed homogenization is performed for 1 to 10 minutes (min), typically for 5 minutes (min). Typically, an IKA, T25 Digital Ultra Turrax® (Germany) is used as high-speed homogenizer.

In an embodiment, the high-speed homogenization as described above is followed by a high-pressure homogenization step. Typically, high-pressure homogenization is performed at 50/450 bar using a 2-stage high-pressure homogenizer. Typically, high-pressure homogenization takes place 3 times in a row. In an embodiment, the high-pressure homogenizer used is a SPXFLOW, APV-1000 lab homogenizer (US).

In the second aspect, the present disclosure relates to a flavored beverage comprising the flavor nanoemulsion described herein.

The term “flavored beverage” includes flavored and cream sodas, powdered soft drinks, as well as liquid concentrates such as fountain syrups and cordials; coffee and coffee-based drinks, coffee substitutes and cereal-based beverages; teas, including dry mix products as well as ready-to-drink teas (herbal and tealeaf based); fruit and vegetable juices and juice flavored beverages as well as juice drinks, nectars, concentrates, punches and “ades”; sweetened and flavored waters, both carbonated and still; sport/energy/health drinks; alcoholic beverages plus alcohol-free and other low-alcohol products including beer and malt beverages, cider, and wines (still, sparkling, fortified wines and wine coolers); other beverages processed with heating (infusions, pasteurization, ultra-high temperature, ohmic heating or commercial aseptic sterilization) and hot-filled packaging; and cold-filled products made through filtration or other preservation techniques.

When the nanomemulsion of the present disclosure is used for the preparation of a flavored beverage, the compounds being comprised by the composition have to be selected such that they are suitable for human consumption. For example, the polar non-aqueous solvents mentioned hereinabove have to be selected such that they are suitable for human consumption. Therefore, butylene glycol and hexylene glycol should not be present in a nanemulsion according to the invention that is used for the preparation of a flavored beverage.

In an embodiment, the flavored beverage comprises the nanoemulsion described herein in an amount of from 0.001 to 5 wt. %, typically of from 0.005 to 0.2 wt. %, more typically of from 0.01 to 0.1 wt. %, based on the total weight of the flavored beverage.

The flavored beverage may be an alcoholic or non-alcoholic beverage. In an embodiment, the beverage is an alcoholic beverage. Typically, the alcoholic beverage comprises ethanol in an amount of from 1 to 15 wt. %, more typically of from 3 to 12 wt. %.

As the inventive nanoemulsion shows sufficient stability under acidic conditions, it can also be present in a beverage showing low pH-values. In an embodiment, the flavored beverage shows an acid pH-value. In a particular embodiment, the flavored beverage shows a pH-value of less than 4, typically less than 3, more typically the beverage has a pH value of 2.8.

In an embodiment of the flavored beverage, flavor oil is present in the beverage in an amount of between 0.001 to 0.5 wt. %, typically from 0.005 to 0.02 wt. %, based on the total weight of the beverage.

In an embodiment of the flavored beverage, the polyglycerol ester of fatty acids (PGE) is present in the beverage in an amount of from 0.0005 to 0.5 wt. %, typically from 0.0007 to 0.004 wt. %, based on the total weight of the beverage.

In an embodiment of the flavored beverage, water is present in the beverage in an amount of from 50 to 98 wt. %, based on the total weight of the beverage. In case of an acidic beverage, water is typically present in the acidic beverage in an amount of from 85 to 95 wt. %, based on the total weight of the beverage. In case of an alcoholic beverage, water is typically present in the alcoholic beverage in an amount of from 50 to 60 wt. %, based on the total weight of the beverage.

The flavored beverage may further comprise one or more food additives. Exemplary additives include, but are not limited to sweeteners, including natural and artificial sweeteners, such as sugar, acesulfame K, aspartame, dextrose, erythritol, fructose, lactose, maltodextrin, mannitol, sodium cyclamate, sodium saccharin, sorbitol, sucralose, xylitol, and the like; preservatives, such as calcium propionate, calcium sorbate, potassium sorbate, sodium benzoate, sodium metabisulphite, sorbic acid, trisodium citrate dihydrate, and the like; antioxidants, such as ascorbic acid (Vitamin C), erythorbic acid, monopropylene glycol, sodium ascorbate, sodium erythorbate, and the like; pH adjusters, such as citric acid, ormaleic acid, and the like; weighting agents, such as brominated vegetable oils, rosin esters and, in particular, ester gums; and coloring, including natural and artificial coloring.

In an embodiment, sugar is present in the beverage in an amount of from 2 to 40 wt. %, based on the total weight of the beverage, typically of from 6 and 27 wt. %.

In an embodiment, citric acid is present in the beverage in an amount of from 0.1 to 3 wt. %, based on the total weight of the beverage, typically of from 0.3 to 1.5 wt. %.

In an embodiment, Vitamin C is present in the beverage in an amount of from 0.0001 to 1 wt. %, based on the total weight of the beverage, typically of from 0.0002 to 0.01 wt. %.

In an embodiment, trisodium citrate dihydrate is present in the beverage in an amount of from 0.0001 to 0.6 wt. %, based on the total weight of the beverage.

In a particular embodiment, the flavored beverage shows a turbidity (NTU) of less than 10, typically less than 5. In an embodiment, the turbidity (NTU) is from 0.2 to 8, more typically from 0.4 to 4.1.

The NTU-value refers to “Nephelometric Turbidity Units” that are representative for the turbidity of a composition, and are measured by means of a turbidimeter as specified by the United States Environmental Protection Agency. Typically, turbidity is measured by a portable turbidity meter (Hanna instruments, Woonsocket, RI, HI93703). Generally, beverages or personal care products having a NTU value above 15 can be considered hazy and not clear. By contrast, beverages having a NTU of less than 10 are considered to have a clear appearance.

The flavored beverage described herein may be made according to any method known to those of ordinary skill in the art. In one suitable method, the flavored beverage is prepared by a method comprising the step of adding the nanoemulsion described herein to a beverage.

Mention is made of the use of the nanoemulsion described herein for the preparation of a flavored beverage.

The nanoemulsion according to the present disclosure may also be used for the preparation of a personal care product. Thus, mention is made of the use of the nanoemulsion described herein for the preparation of a personal care product.

Personal care products are typically applied to the human body for the purposes of cleaning, beautifying, promoting attractiveness or changing its appearance.

Personal care products are for example, toothpaste or mouthwashes.

In a particular embodiment, the inventive nanoemulsion is used for the preparation of a mouthwash. Mouthwashes or mouth rinses are liquid oral care preparations developed to clean and refresh the oral cavity or oral surface by inhibiting or killing the microorganisms that cause malodor, dental caries, tooth decay, gum diseases, gingivitis, and periodontal disorders.

The compositions, methods, and uses thereof, according to the present disclosure are further illustrated by the following non-limiting examples.

### Example 1. Preparation of Flavor Nanoemulsions

Flavor nanoemulsion compositions were prepared and shown in Tables 1a-1d below. The aqueous phases were prepared by mixing polyglycerol esters of fatty acids (decaglyceryl monooleate, available as SY-Glyster MO-7S from SAKAMOTO YAKUHIN or Polyaldo® 10-1-O from Lonza Inc.) with water and water-soluble ingredients, if applicable. As oil phases, selected flavor oils were blended with Vitamin E at room temperature. The flavor nanoemulsions were pre-emulsified using a high-speed homogenizer (IKA, T25 Digital Ultra Turrax®, Germany) at 10,000 rpm for 5 mins, and the resulting pre-emulsions were homogenized at 450/50 bar for 3 times using a 2-stage high pressure homogenizer (SPXFLOW, APV-1000 lab homogenizer, US). Droplet sizes of the flavor nanoemulsions were measured by Zetasizer (Malvern Panalytical Ltd, Zetasizer Nano ZS, UK).

TABLE 1a
Flavor nanoemulsion compositions

| | a | b | c | d | e |
|---|---|---|---|---|---|
| Ingredients | (wt %) | (wt %) | (wt %) | (wt %) | (wt %) |
| Lemon oil | 10 | — | — | — | — |
| Grapefruit oil | — | 10 | — | — | — |
| Lime oil | — | — | 10 | — | — |
| Orange oil | — | — | — | 10 | — |
| Calamansi | — | — | — | — | 10 |
| flavor | | | | | |
| Vitamin E | 0.025 | 0.025 | 0.025 | 0.025 | 0.025 |
| SY-Glyster | 12 | 12 | 12 | 12 | 12 |
| MO-7S | | | | | |
| Glycerol | 35 | 35 | 35 | 35 | 35 |
| Water | Q.S. | Q.S. | Q.S. | Q.S. | Q.S. |
| | to 100 | to 100 | to 100 | to 100 | to 100 |
| Z-average (nm) | 95.22 | 99.92 | 84.08 | 81.42 | 107.1 |

TABLE 1b
Flavor nanoemulsion compositions (cont'd)

| | f | g | h | i | j |
|---|---|---|---|---|---|
| Ingredients | (wt %) | (wt %) | (wt %) | (wt %) | (wt %) |
| Lemon oil | — | 10 | — | — | — |
| Grapefruit oil | — | — | 10 | — | — |
| Lime oil | — | — | — | 10 | — |
| Orange oil | — | — | — | — | 10 |
| Limonene | 10 | — | — | — | — |
| Vitamin E | 0.025 | 0.025 | 0.025 | 0.025 | 0.025 |
| SY-Glyster | 12 | — | — | — | — |
| MO-7S | | | | | |
| Polyaldo ® | — | 14 | 14 | 14 | 14 |
| 10-1-O | | | | | |
| Glycerol | 35 | 35 | 35 | 35 | 35 |
| Water | Q.S. | Q.S. | Q.S. | Q.S. | Q.S. |
| | to 100 | to 100 | to 100 | to 100 | to 100 |
| Z-average (nm) | 115.8 | 116.1 | 117.2 | 112.8 | 108.2 |

TABLE 1c
Flavor nanoemulsion compositions (cont'd)

| | k | l | m | n | o |
|---|---|---|---|---|---|
| Ingredients | (wt %) | (wt %) | (wt %) | (wt %) | (wt %) |
| Lemon oil | 10 | 10 | 10 | 10 | 20 |
| Vitamin E | 0.025 | 0.025 | 0.025 | 0.025 | 0.025 |
| Polyaldo ® | 8 | 10 | 12 | 16 | 12 |
| 10-1-O | | | | | |
| Water | Q.S. | Q.S. | Q.S. | Q.S. | Q.S. |
| | to 100 | to 100 | to 100 | to 100 | to 100 |
| Z-average (nm) | 123.5 | 120.1 | 121.2 | 114.4 | 134.4 |

TABLE 1d
Flavor nanoemulsion compositions (cont'd)

| | p | b | r | s | t | u |
|---|---|---|---|---|---|---|
| Ingredients | (wt %) | (wt %) | (wt %) | (wt %) | (wt %) | (wt %) |
| Lemon oil | 20 | 20 | — | — | — | — |
| Limonene | — | — | 10 | 10 | 10 | 10 |
| Vitamin E | 0.025 | 0.025 | 0.025 | 0.025 | 0.025 | 0.025 |
| Polyaldo ® | 14 | 16 | 6 | 8 | 10 | 12 |
| 10-1-O | | | | | | |
| Glycerol | — | — | 35 | 35 | 35 | 35 |
| Water | Q.S. | Q.S. | Q.S. | Q.S. | Q.S. | Q.S. |
| | to 100 | to 100 | to 100 | to 100 | to 100 | to 100 |
| Z-average | 131.5 | 133.8 | 126.8 | 119.3 | 106.1 | 98.82 |
| (nm) | | | | | | |

### Example 2. Preparation of Flavored Beverages

The flavor nanoemulsions prepared according to Example 1 were applied to the acidic beverages (pH 2.8) as shown in Tables 2a-2d below. Samples A to U were prepared using flavor composition a-u, respectively. The turbidity of the final beverages was measured using a portable turbidimeter (Hanna instruments, HI93703, US) and reported in Nephelometric Turbidity Unit (NTU).

TABLE 2a
Acidic beverage compositions

| Ingredients | A (g) | B (g) | C (g) | D (g) | E (g) |
|---|---|---|---|---|---|
| Flavor nanoemulsion a | 0.1 | — | — | — | — |
| Flavor nanoemulsion b | — | 0.1 | — | — | — |
| Flavor nanoemulsion c | — | — | 0.1 | — | — |
| Flavor nanoemulsion d | — | — | — | 0.1 | — |
| Flavor nanoemulsion e | — | — | — | — | 0.1 |
| Sugar | 60.00 | 60.00 | 60.00 | 60.00 | 60.00 |
| Citric acid anhydrous | 3.00 | 3.00 | 3.00 | 3.00 | 3.00 |
| Ascorbic Acid | 0.20 | 0.20 | 0.20 | 0.20 | 0.20 |
| Trisodium citrate | 0.5 | 0.5 | 0.5 | 0.5 | 0.5 |
| dihydrate | | | | | |
| Water | Q.S. to | Q.S. to | Q.S. to | Q.S. to | Q.S. to |
| | 1000.00 | 1000.00 | 1000.00 | 1000.00 | 1000.00 |
| Turbidity (NTU) of the | 0.94 | 1 | 1.29 | 0.94 | 0.67 |
| final beverage | | | | | |

TABLE 2b
Acidic beverage compositions (cont'd)

| Ingredients | F (g) | G (g) | H (g) | I (g) | J (g) |
|---|---|---|---|---|---|
| Flavor nanoemulsion f | 0.1 | — | — | — | — |
| Flavor nanoemulsion g | — | 0.2 | — | — | — |
| Flavor nanoemulsion h | — | — | 0.2 | — | — |
| Flavor nanoemulsion i | — | — | — | 0.2 | — |
| Flavor nanoemulsion j | — | — | — | — | 0.2 |
| Sugar | 60.00 | 60.00 | 60.00 | 60.00 | 60.00 |
| Citric acid anhydrous | 3.00 | 3.00 | 3.00 | 3.00 | 3.00 |
| Ascorbic Acid | 0.20 | 0.20 | 0.20 | 0.20 | 0.20 |
| Trisodium citrate | 0.5 | 0.5 | 0.5 | 0.5 | 0.5 |
| dihydrate | | | | | |
| Water | Q.S. to | Q.S. to | Q.S. to | Q.S. to | Q.S. to |
| | 1000.00 | 1000.00 | 1000.00 | 1000.00 | 1000.00 |
| Turbidity (NTU) of the | 1.43 | 3.12 | 3.3 | 3.04 | 2.84 |
| final beverage | | | | | |

TABLE 2c
Acidic beverage compositions (cont'd)

| Ingredients | K (g) | L (g) | M (g) | N (g) | O (g) | P (g) |
|---|---|---|---|---|---|---|
| Flavor nanoemulsion k | 0.1 | — | — | — | — | — |
| Flavor nanoemulsion l | — | 0.1 | — | — | — | — |
| Flavor nanoemulsion m | — | — | 0.1 | — | — | — |
| Flavor nanoemulsion n | — | — | — | 0.1 | — | — |
| Flavor nanoemulsion o | — | — | — | — | 0.1 | — |
| Flavor nanoemulsion p | — | — | — | — | — | 0.1 |
| Sugar | 60.00 | 60.00 | 60.00 | 60.00 | 60.00 | 60.00 |
| Citric acid anhydrous | 3.00 | 3.00 | 3.00 | 3.00 | 3.00 | 3.00 |
| Ascorbic Acid | 0.20 | 0.20 | 0.20 | 0.20 | 0.20 | 0.20 |
| Trisodium citrate | 0.5 | 0.5 | 0.5 | 0.5 | 0.5 | 0.5 |
| dihydrate | | | | | | |
| Water | Q.S. to | Q.S. to | Q.S. to | Q.S. to | Q.S. to | Q.S. to |
| | 1000.00 | 1000.00 | 1000.00 | 1000.00 | 1000.00 | 1000.00 |
| Turbidity (NTU) of the | 1.18 | 1.19 | 1.46 | 1.68 | 2.47 | 4.09 |
| final beverage | | | | | | |

TABLE 2d
Acidic beverage compositions (cont'd)

| Ingredients | Q (g) | R (g) | S (g) | T (g) | U (g) |
|---|---|---|---|---|---|
| Flavor nanoemulsion q | 0.1 | — | — | — | — |
| Flavor nanoemulsion r | — | 0.1 | — | — | — |
| Flavor nanoemulsion s | — | — | 0.1 | — | — |
| Flavor nanoemulsion t | — | — | — | 0.1 | — |
| Flavor nanoemulsion u | | | | | 0.1 |
| Sugar | 60.00 | 60.00 | 60.00 | 60.00 | 60.00 |
| Citric acid anhydrous | 3.00 | 3.00 | 3.00 | 3.00 | 3.00 |
| Ascorbic Acid | 0.20 | 0.20 | 0.20 | 0.20 | 0.20 |
| Trisodium citrate | 0.5 | 0.5 | 0.5 | 0.5 | 0.5 |
| dihydrate | | | | | |
| Water | Q.S. to | Q.S. to | Q.S. to | Q.S. to | Q.S. to |
| | 1000.00 | 1000.00 | 1000.00 | 1000.00 | 1000.00 |
| Turbidity (NTU) of the | 2.96 | 1.68 | 0.88 | 0.45 | 0.59 |
| final beverage | | | | | |

As can be seen in Tables 2a-2d, the flavor nanoemulsion formulae can be applied to different types of flavor while also maintaining clear beverages with turbidity values of the final beverages being below 5 NTU.

The disclosed subject matter has been described with reference to specific details or particular embodiments thereof. It is not intended that such details be regarded as limitations upon the scope of the disclosed subject matter except insofar as and to the extent that they are included in the accompanying claims.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those of ordinary skill in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The exemplary embodiments described herein illustratively disclosed herein suitably may be practiced in the absence of any element that is not specifically disclosed herein and/or any optional element disclosed herein.

1. A flavor nanoemulsion comprising:
a surfactant system comprising a polyglycerol ester of fatty acids (PGE),
a non-polar phase comprising a flavor oil, and
a polar phase;
wherein the flavor nanoemulsion is free of any polyoxyethylene sorbitan fatty acid esters.

2. The flavor nanoemulsion of claim 1, wherein the intensity weighted mean hydrodynamic diameter (Z-average value) of the oil droplets in the nanoemulsion is from 50 to 150 nm.

3. The flavor nanoemulsion of claim 1, wherein the surfactant system consists of a polyglycerol ester of fatty acids (PGE).

4. The flavor nanoemulsion according to claim 1, wherein the polyglycerol ester of fatty acids has a degree of polymerization of from 2 to 10 glycerol units and/or the fatty acids in the polyglycerol ester have a carbon number of from 12 to 18.

5. The flavor nanoemulsion according to claim 1, wherein the polyglycerol ester of fatty acids (PGE) is selected from the group consisting of triglyceryl monostearate, hexaglycerol penta-stearate, hexaglycerol tri-stearate, tetraglycerol mono-oleate, decaglycerol mono-oleate, and any mixture thereof.

6. The flavor nanoemulsion according to claim 1, wherein the polyglycerol ester of fatty acids (PGE) has an HLB-value of less than 16.

7. The flavor nanoemulsion according to claim 1, wherein the nanoemulsion comprises the polyglycerol ester of fatty acids (PGE) in an amount of from 1 to 20 wt. %, based on the total weight of the nanoemulsion, typically from 6 to 16 wt. %.

8. The flavor nanoemulsion according to claim 1, wherein the nanoemulsion comprises the flavor oil in an amount of from 0.5 to 30 wt. %, based on the total weight of the nanoemulsion.

9. The flavor nanoemulsion according to claim 1, wherein the polar phase comprises water and/or one or more polar non-aqueous solvents.

10. The flavor nanoemulsion according to claim 1, wherein the nanoemulsion comprises water in an amount of from 20 to 85 wt. %, based on the total weight of the nanoemulsion.

11. The flavor nanoemulsion according to claim 1, wherein the polar phase comprises glycerol.

12. The flavor nanoemulsion according claim 11, wherein the nanoemulsion comprises glycerol in an amount of from 0.1 to 70 wt. %, based on the total weight of the nanoemulsion.

13. The flavor nanoemulsion according to claim 11, wherein the mass ratio of glycerol to the polyglycerol ester of fatty acids (PGE) is from 20:1 to 1:20.

14. A flavored beverage comprising the flavor nanoemulsion according to claim 1.

15. The flavored beverage of claim 14, wherein the beverage is an acid beverage and/or an alcoholic beverage.

16. The flavored beverage of claim 15, wherein the beverage is an acid beverage having a pH value of less than 4.

17. The flavor nanoemulsion according to claim 7, wherein the nanoemulsion comprises the polyglycerol ester of fatty acids (PGE) in an amount of from 6 to 16 wt. %, based on the total weight of the nanoemulsion.

18. The flavor nanoemulsion according to claim 8, wherein the nanoemulsion comprises the flavor oil in an amount of from 5 to 25 wt. %, based on the total weight of the nanoemulsion.

19. The flavor nanoemulsion according claim 12, wherein the nanoemulsion comprises glycerol in an amount of from 1 to 40 wt. %, based on the total weight of the nanoemulsion.

20. The flavor nanoemulsion according to claim 13, wherein the mass ratio of glycerol to the polyglycerol ester of fatty acids (PGE) is from 10:1 to 1:10.
